(19) United States
(12) Patent Application Publication
(10) Pub. No.: US 2014/0181066 A1
(43) Pub. Date: Jun. 26, 2014

(54) INTEREST MATCHING TECHNIQUES USING INTERNET SEARCHES

(71) Applicant: Quentral S.r.I., Milano (IT)

(72) Inventors: Luca Martino Giorcelli, Milano (IT); Mariano Pireddu, Oristano (IT)

(73) Assignee: Quentral S.r.I., Milano (IT)

(21) Appl. No.: 13/724,982

(22) Filed: Dec. 21, 2012

(51) Int. Cl. G06F 17/30

(52) U.S. Cl. CPC G06F 17/30864
USPC 707/706

(57) ABSTRACT

According to certain techniques, a first search engine result page (“SERP”) is obtained. The first SERP is associated with a first user. A second SERP is obtained, and the second SERP is associated with a second user. The first SERP is compared with the second SERP to determine an overall degree of correlation. The first SERP may include at least one of a query, at least one title, at least one uniform resource locator (“URL”), at least one snippet, or at least one related search. The second SERP may include at least one of at least one query, at least one title, at least one URL, at least one snippet, or at least one related search.

### CROSS REFERENCE TO RELATED APPLICATIONS

[Not Applicable]

### FEDERALLY SPONSORED RESEARCH OR DEVELOPMENT

[Not Applicable]

### JOINT RESEARCH AGREEMENT

[Not Applicable]

### SEQUENCE LISTING

[Not Applicable]

### BACKGROUND

Generally, this application relates to interest matching techniques using internet searches.

Social networking (available through closed websites, such as Facebook® and LinkedIn® may allow a user to network with other users. These other users may be people whom the user already knows, such as family members, colleagues, peers, classmates, friends, or the like. It may be helpful to provide social networking between people who do not necessarily know each other, but who share a common interest.

### BRIEF SUMMARY

According to certain techniques, a first search engine result page (“SERP”) is obtained. The first SERP is associated with a first user. A second SERP is obtained, and the second SERP is associated with a second user. The first SERP is compared with the second SERP to determine an overall degree of correlation. The first SERP may include at least one of a query, at least one title, at least one uniform resource locator (“URL”), at least one snippet, or at least one related search. The second SERP may include at least one of at least one query, at least one title, at least one URL, at least one snippet, or at least one related search.

The first SERP may be compared with the second SERP by at least one of the following: comparing the query of the first SERP with the query of the second SERP to determine a query degree of correlation; comparing the at least one title of the first SERP with the at least one title of the second SERP to determine a title degree of correlation; comparing the at least one URL of the first SERP with the at least one URL of the second SERP to determine a URL degree of correlation; comparing the at least one snippet of the first SERP with at least one the snippet of the second SERP to determine a snippet degree of correlation; or comparing the at least one related search of the first SERP with the at least one related search of the second SERP to determine a related search degree of correlation.

The first SERP may be compared with the second SERP by at least two of the following: comparing the query of the first SERP with the query of the second SERP to determine a query degree of correlation; comparing the at least one title of the first SERP with the at least one title of the second SERP to determine a title degree of correlation; comparing the at least one URL of the first SERP with the at least one URL of the second SERP to determine a URL degree of correlation; comparing the at least one snippet of the first SERP with the at least one snippet of the second SERP to determine a snippet degree of correlation; or comparing the at least one related search of the first SERP with the at least one related search of the second SERP to determine a related search degree of correlation. The first SERP may be compared with the second SERP by assigning different weights to at least two of the query degree of correlation, the title degree of correlation, the URL degree of correlation, the snippet degree of correlation, or the related search degree of correlation. The overall degree of correlation may be determined based at least in part on these other degrees of correlation.

If the overall degree of correlation is greater than a threshold, an indication of the existence of the second user may be communicated to the first user. If the overall degree of correlation is greater than the threshold, the query of the second SERP may be communicated to the first user. If the overall degree of correlation is greater than the threshold, the identity of the second user may be communicated to the first user.

According to certain techniques, a system includes at least one processor and at least one memory having instructions that are executable by the processor to cause the system to perform operations. These operations may include obtaining a first SERP associated with a first user and a second SERP associated with a second user. The first SERP is compared with the second SERP to determine an overall degree of correlation. The first SERP may include at least one of a query, at least one title, at least one uniform resource locator (“URL”), at least one snippet, or at least one related search. The second SERP may include at least one of a query, at least one title, at least one URL, at least one snippet, or at least one related search.

The operations may also include comparing the first SERP with the second SERP by at least one of: comparing the query of the first SERP with the query of the second SERP to determine a query degree of correlation; comparing the at least one title of the first SERP with the at least one title of the second SERP to determine a title degree of correlation; comparing the at least one URL of the first SERP with the at least one URL of the second SERP to determine a URL degree of correlation; comparing the at least one snippet of the first SERP with the at least one snippet of the second SERP to determine a snippet degree of correlation; or comparing the at least one related search of the first SERP with the at least one related search of the second SERP to determine a related search degree of correlation.

The operations may also include comparing the first SERP with the second SERP by at least two of: comparing the query of the first SERP with the query of the second SERP to determine a query degree of correlation; comparing the at least one title of the first SERP with the at least one title of the second SERP to determine a title degree of correlation; comparing the at least one URL of the first SERP with the at least one URL of the second SERP to determine a URL degree of correlation; comparing the at least one snippet of the first SERP with the at least one snippet of the second SERP to determine a snippet degree of correlation; or comparing the at least one related search of the first SERP with the at least one related search of the second SERP to determine a related search degree of correlation.

The operations may also include assigning different weights to at least two of the query degree of correlation, the title degree of correlation, the URL degree of correlation, the snippet degree of correlation, or the related search degree of correlation.

If the overall degree of correlation is greater than a threshold, the operations may further include transmitting an indication of the existence of the second user to the first user. If the overall degree of correlation is greater than the threshold, the query of the second SERP may be communicated to the first user. If the overall degree of correlation is greater than the threshold, the identity of the second user may be communicated to the first user.

According to certain techniques, at least one computer-readable medium includes instructions executable to cause a system to perform operations. These operations may include obtaining a first SERP associated with a first user and a second SERP associated with a second user. The first SERP is compared with the second SERP to determine an overall degree of correlation. The first SERP may include at least one of a query, at least one title, at least one uniform resource locator (“URL”), at least one snippet, or at least one related search. The second SERP may include at least one of at least one query, at least one title, at least one URL, at least one snippet, or at least one related search.

The operations may also include comparing the first SERP with the second SERP by at least one of: comparing the query of the first SERP with the query of the second SERP to determine a query degree of correlation; comparing the at least one title of the first SERP with the at least one title of the second SERP to determine a title degree of correlation; comparing the at least one URL of the first SERP with the at least one URL of the second SERP to determine a URL degree of correlation; comparing the at least one snippet of the first SERP with the at least one snippet of the second SERP to determine a snippet degree of correlation; or comparing the at least one related search of the first SERP with the at least one related search of the second SERP to determine a related search degree of correlation.

The operations may also include comparing the first SERP with the second SERP by at least two of: comparing the query of the first SERP with the query of the second SERP to determine a query degree of correlation; comparing the at least one title of the first SERP with the at least one title of the second SERP to determine a title degree of correlation; comparing the at least one URL of the first SERP with the at least one URL of the second SERP to determine a URL degree of correlation; comparing the at least one snippet of the first SERP with the at least one snippet of the second SERP to determine a snippet degree of correlation; or comparing the at least one related search of the first SERP with the at least one related search of the second SERP to determine a related search degree of correlation.

The operations may also include assigning different weights to at least two of the query degree of correlation, the title degree of correlation, the URL degree of correlation, the snippet degree of correlation, or the related search degree of correlation.

If the overall degree of correlation is greater than a threshold, the operations may further include transmitting an indication of the existence of the second user to the first user. If the overall degree of correlation is greater than the threshold, the query of the second SERP may be communicated to the first user. If the overall degree of correlation is greater than the threshold, the identity of the second user may be communicated to the first user.

### BRIEF DESCRIPTION OF SEVERAL VIEWS OF THE DRAWINGS

FIG. 1 illustrates three users, each associated with queries and SERPs.

FIGS. 2A-2C illustrate three different SERPS.

FIG. 3A illustrates a comparison of two different SERPs, according to techniques of the present application.

FIG. 3B illustrates a comparison of two different SERPs, according to techniques of the present application.

FIG. 4 shows an evaluation of interest matching between users, according to techniques of the present application.

FIG. 5 shows an evaluation of interest matching between users, according to techniques of the present application.

FIG. 6 illustrates a flowchart for a method of determining interest matching between users, according to techniques of the present application.

FIGS. 7A-7F illustrate screenshots of a browsing application, according to techniques of the present application.

FIG. 8 illustrates a computing system, according to techniques of the present application.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

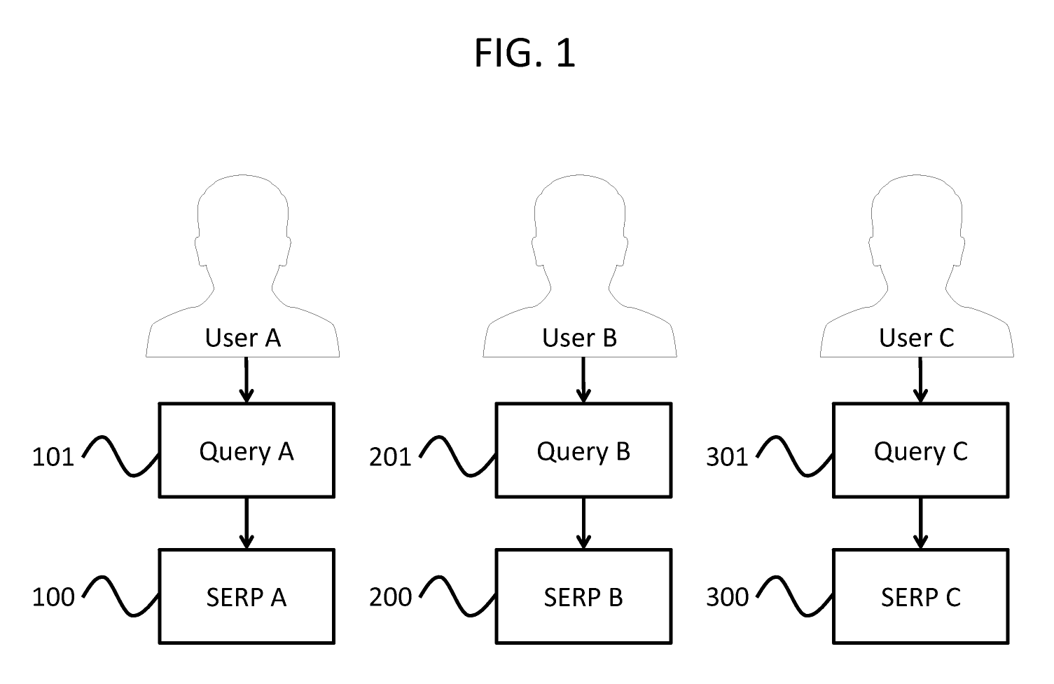

When a user performs an internet search (for example, through a search engine like Google®), the user may enter a query and receive a search engine results page (“SERP”). FIG. 1 illustrates three users, User A, User B, and User C. User A enters Query A 101 into a search engine and is returned a search engine results page SERP A 100. User B enters Query B 201 into a search engine and is returned SERP B 200. User C enters Query C 301 into a search engine and is returned SERP C 300.

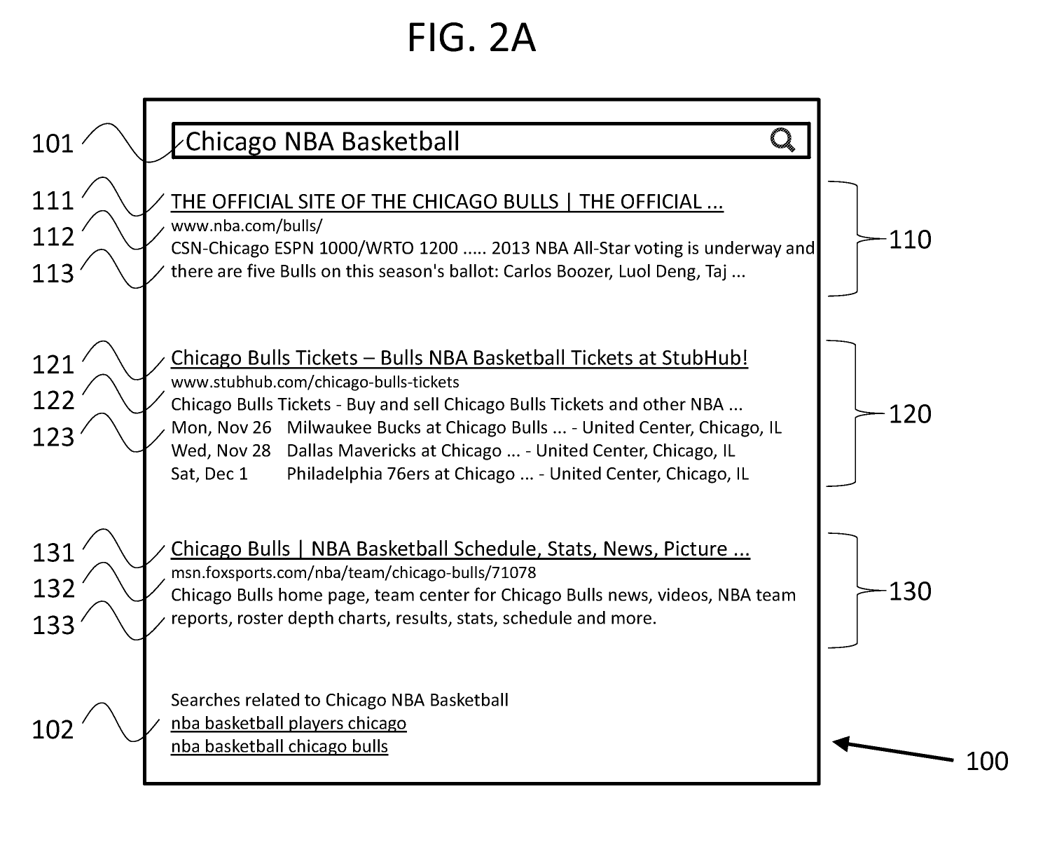

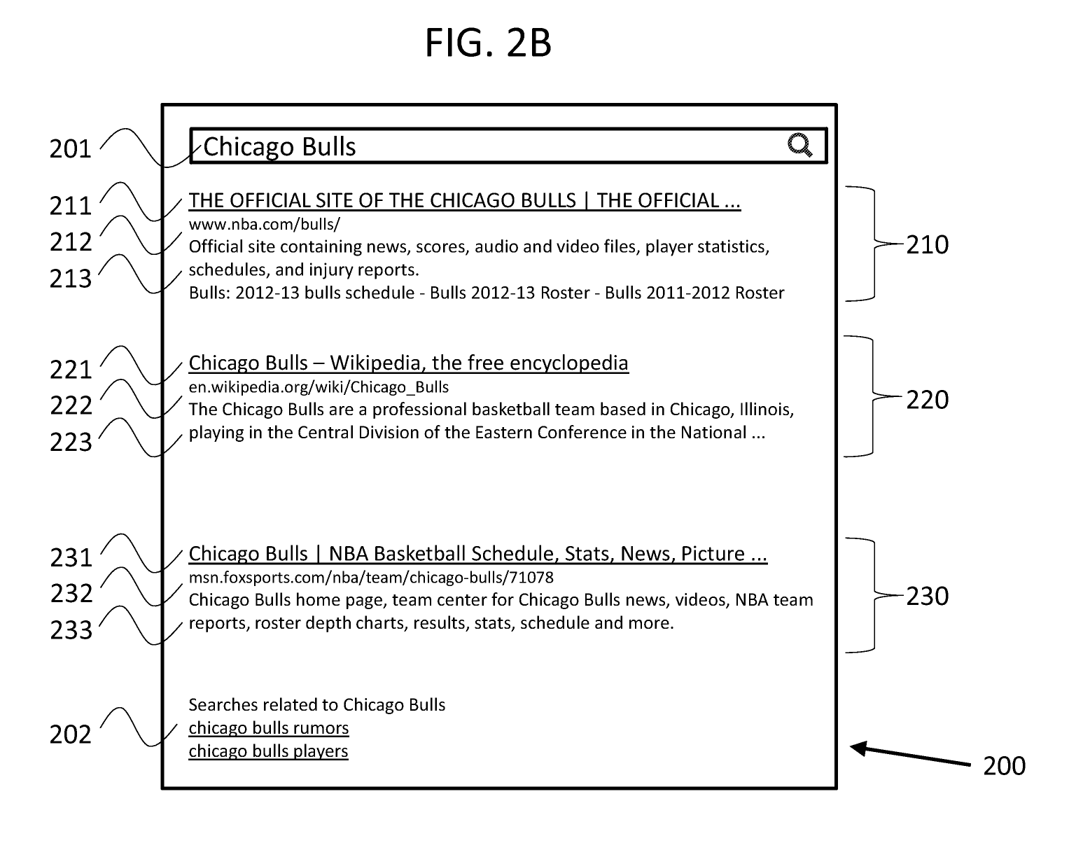

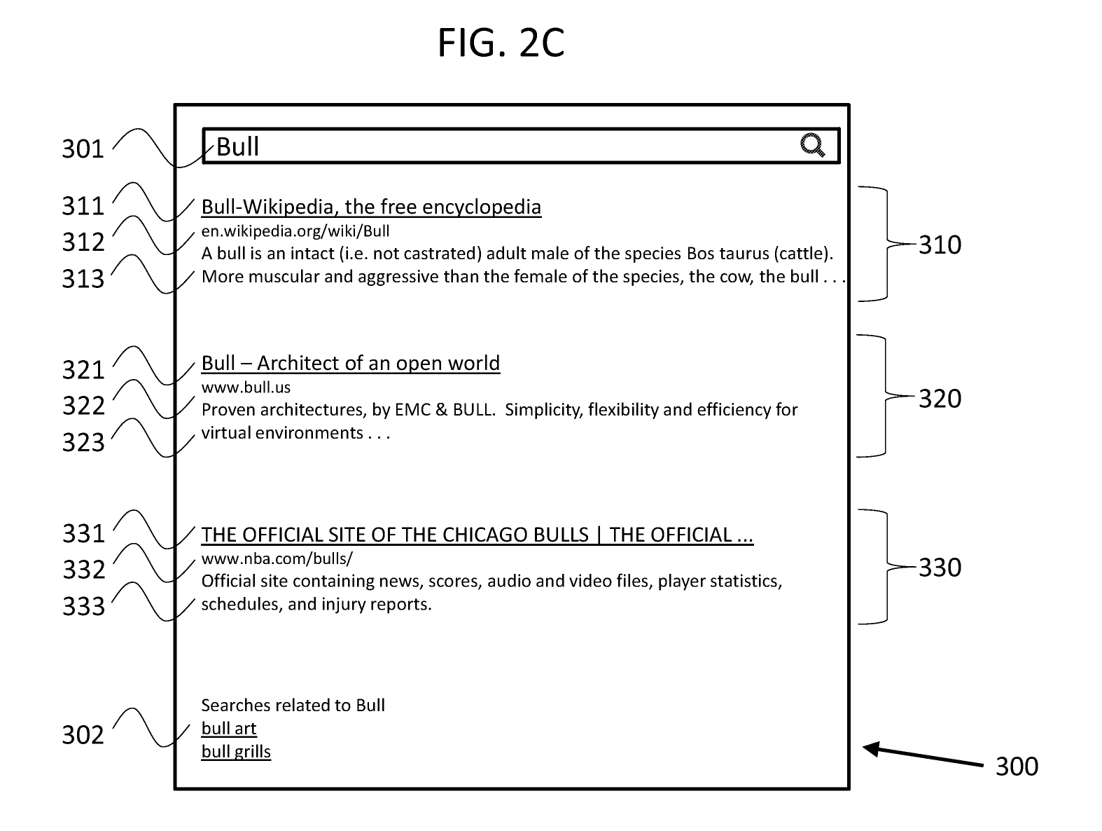

FIGS. 2A-2C illustrate the content of SERP A 100, SERP B 200, and SERP C 300. As shown in FIG. 2A, Query A 101—“Chicago NBA Basketball”—generated SERP A 100. SERP A 100 may include Query A 101 and related searches 102. Note, Query A 101 may be both entered into a search engine to obtain SERP A 100 and returned as part of SERP A 100. SERP A 100 may also include a series of listings 110, 120, and 130. Listing 110 may include a title 111, a uniform resource locator (“URL”) 112, or a snippet 113. Listing 120 may include a title 121, a URL 122, or a snippet 123. Listing 130 may include a title 131, a URL 132, or a snippet 133. The snippets 113, 123, and 133 may be excerpts from webpages found at the location specified by the corresponding URLs 112, 122, and 132. The content of the snippets 113, 123, and 133 may be chosen by the search engine, for example, based on the perceived relevance of the webpage specified by the URLs 112, 122, and 132 as compared to the Query A 101.

As shown in FIG. 2B, Query B 201—“Chicago Bulls”—generated SERP B 200. SERP B 200 may include Query B 201 and related searches 202. Note, Query B 201 may be both entered into a search engine to obtain SERP B 200 and returned as part of SERP B 200. SERP B 200 may also include a series of listings 210, 220, and 230. Listing 210 may include a title 211, a URL 212, or a snippet 213. Listing 220 may include a title 221, a URL 222, or a snippet 223. Listing 230 may include a title 221, a URL 232, or a snippet 233. The snippets 213, 223, and 233 may be excerpts from webpages found at the location specified by the corresponding URLs 212, 222, and 232. The content of the snippets 213, 223, and 233 may be chosen by the search engine, for example, based on the perceived relevance of the webpage specified by the URLs 212, 222, and 232 as compared to the Query B 201.

As shown in FIG. 2C, Query C 301—“Bull”—generated SERP C 300. SERP C 300 may include Query C 301 and related searches 302. Note, Query C 301 may be both entered into a search engine to obtain SERP C 300 and returned as part of SERP C 300. SERP C 300 may also include a series of listings 310, 320, and 330. Listing 310 may include a title 311, a URL 312, or a snippet 313. Listing 320 may include a title 321, a URL 322, or a snippet 323. Listing 330 may include a title 321, a URL 332, or a snippet 333. The snippets 311, 321, and 331 may be excerpts from webpages found at the location specified by the corresponding URLs 312, 322, and 332. The content of the snippets 311, 321, and 331 may be chosen by the search engine, for example, based on the perceived relevance of the webpage specified by the URLs 312, 322, and 332 as compared to the Query C 301.

Two or more SERPs may be compared with each other to determine a degree of correlation between each other. What follows is a description of but a few examples as to how SERPs can be compared with each other.

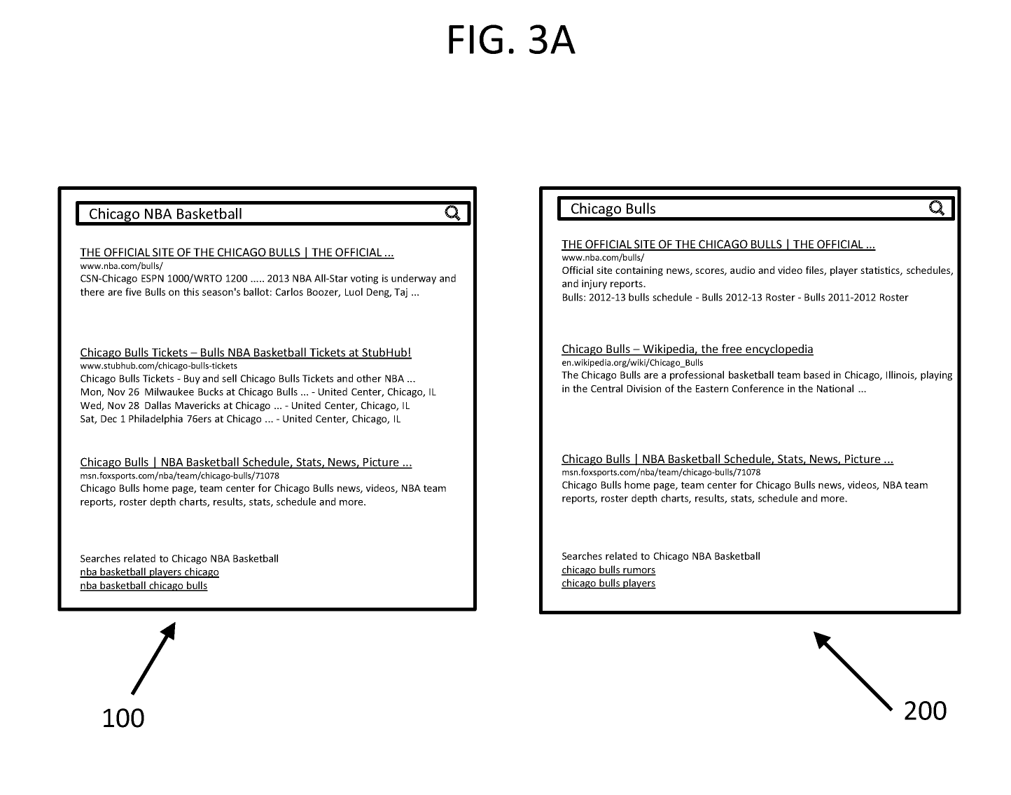

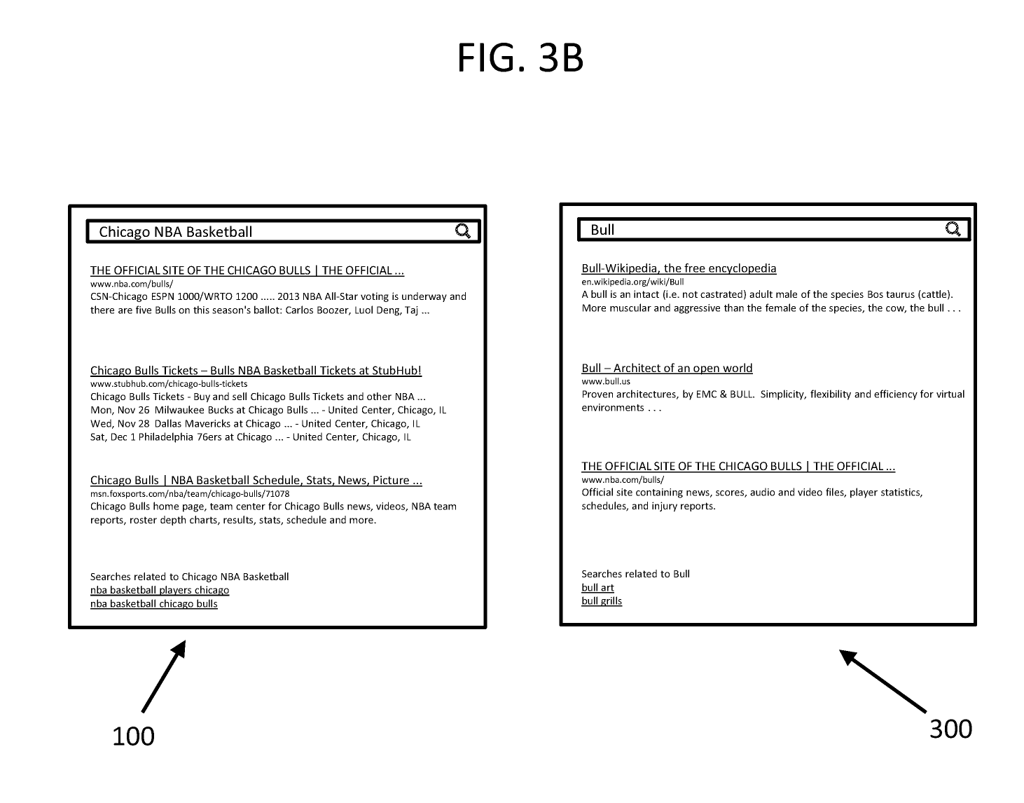

As illustrated in FIG. 3A, different parts of SERP A 100 may be compared with corresponding parts of SERP B 200. Note, some reference numerals have been omitted from FIGS. 3A and 3B for the sake of clarity. The omitted reference numerals are the same as those shown in FIGS. 2A and 2B.

Query A 101 may be compared with Query B 201. In this case, the word “Chicago” is shared, so there is at least some degree of correlation between Query A 101 and Query B 201.

One or more related searches 102 may be compared with one or more related searches 202 to determine a related search degree of correlation. In this case, there is some degree of correlation between related searches 102 and related searches 202 because the language “chicago,” “chicago bulls,” and “players” is shared.

Any of listings 110, 120, or 130 may be compared to any other of listings 210, 220, or 230. For example, listing 110 may be compared to listing 210, 220, and/or 230. One of listings 210, 220, or 230 may be selected for comparison to listing 110 based on a best-match determination. As an example, listing 110 may be compared to listing 210. Analyzing this comparison, it can be seen that title 111 is identical to title 211 and that URL 112 is identical to URL 212. As another example, listing 120 may be compared to listing 220. In this instance, there is some correlation between titles 121 and 221 (“Chicago Bulls”) and between URLs 122 and 222 (“Chicago Bulls”). There is also some correlation between snippets 123 and 223 (“Chicago Bulls” and “Chicago”). As another example, listing 130 may be compared to listing 230. In this instance, it can be seen that listing 130 is identical to listing 230. In addition to comparing titles, URLs, or snippets, it may also be possible to compare other aspects of listings, such as page rank (for example, comparing page rank of listing 110 with that of listing 210).

As another example, two or more aggregated titles 111, 121, and 131 may be compared with two or more aggregated titles 211, 221, and 231. As another example, two or more aggregated URLs 112, 122, and 132 may be compared with two or more aggregated URLs 212, 222, and 232. As another example, two or more aggregated snippets 113, 123, and 133 may be compared with two or more aggregated snippets 213, 223, and 233.

Based on various comparisons, a degree of correlation between SERP A 100 and SERP B 200 may be obtained. It may be possible to weight different comparisons when determining the degree of correlation. For example, the result of a title comparison may be weighted more than the results of a snippet comparison. As another example, the result of the Query A 101 and Query B 201 comparison may be weighted more than the result of the related searches 102 and related searches 202. As another example, weighting formulas may factor in the page rank of a given listing in a SERP.

The comparisons may result in numbers, such as percentages or some other metric that assesses the correlation between certain items. After all comparison and weighting calculations have been performed, an overall degree of correlation between SERP A 100 and SERP B 200 is determined. The overall degree of correlation may reflect other aspects, such as IP addresses or geographical proximity between users, for example. We shall assume, for example only, that there is a strong degree of correlation between SERP A 100 and SERP B 200.

As illustrated in FIG. 3B, different parts of SERP A 100 may be compared with corresponding parts of SERP C 300. Note, some reference numerals have been omitted from FIGS. 3A and 3B for the sake of clarity. The omitted reference numerals are the same as those shown in FIGS. 2A and 2C.

Query A 101 may be compared with Query C 301. In this case, there is no shared language, so there may not be any correlation between Query A 101 and Query C 301.

Related searches 102 may be compared with related searches 302. In this case, there is some degree of correlation because the language “bull” or “bulls” is shared.

Any of listings 110, 120, or 130 may be compared to any other of listings 310, 320, or 330. For example, listing 110 may be compared to listing 310, 320, and/or 330. One of listings 310, 320, or 330 may be selected for comparison to listing 110 based on a best-match determination. As an example, listing 110 may be compared to listing 330. Analyzing this comparison, it can be seen that title 111 is identical to title 331 and that URL 112 is identical to URL 332. Snippets 113 and 333 can be seen to be somewhat different. As another example, listing 120 may be compared to listing 310. Title 121 shares the word “bull/bulls” with title 311. URL 122 shares the word “bull/bulls” with URL 312. The snippets 123 and 313 also share the word “bull/bulls.” As another example, listing 130 may be compared to listing 320. Title 131 shares the word “bull/bulls” with title 321. URL 132 shares the word “bull/bulls” with URL 322. The snippets 133 and 323 also share the word “bull/bulls.” In addition to comparing titles, URLs, or snippets, it may also be possible to compare other aspects of listings, such as page rank (for example, comparing the location of listing 110 in SERP A 100 with that of listing 330 in SERP C 300).

As another example, two or more aggregated titles 111, 121, and 131 may be compared with two or more aggregated titles 311, 321, and 331. As another example, two or more aggregated URLs 112, 122, and 132 may be compared with two or more aggregated URLs 312, 322, and 332. As another example, two or more aggregated snippets 113, 123, and 133 may be compared with two or more aggregated snippets 313, 323, and 333.

Based on various comparisons, a degree of correlation between SERP A 100 and SERP C 300 may be obtained. It may be possible to weight different comparisons when determining the degree of correlation. For example, the result of a title comparison may be weighted more than the results of a snippet comparison. As another example, the result of the Query A 101 and Query C 301 comparison may be weighted more than the result of the related searches 102 and related searches 302. As another example, weighting formulas may factor in the page rank of a given listing in a SERP.

The comparisons may result in numbers, such as percentages or some other metric that assesses the correlation between certain items. After all comparison and weighting calculations have been performed, an overall degree of correlation between SERP A 100 and SERP C 300 is determined. We shall assume, for example only, that there is a weak degree of correlation between SERP A 100 and SERP C 300.

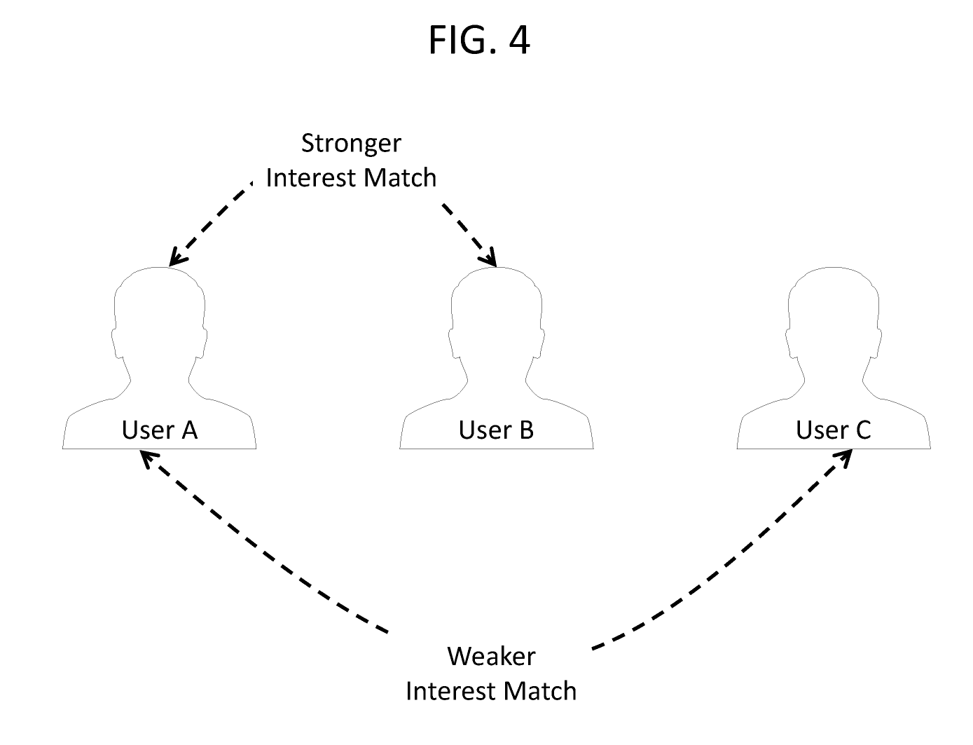

FIG. 4A illustrates that there may be a relatively strong interest match between User A and User B. This strong interest match may be because of the exemplary strong degree of correlation between SERP A 100 and SERP B 200. FIG. 4B illustrates that there may be a relatively weak interest match between User A and User C. This weak interest match may be because of the exemplary weak degree of correlation between SERP A 100 and SERP C 300.

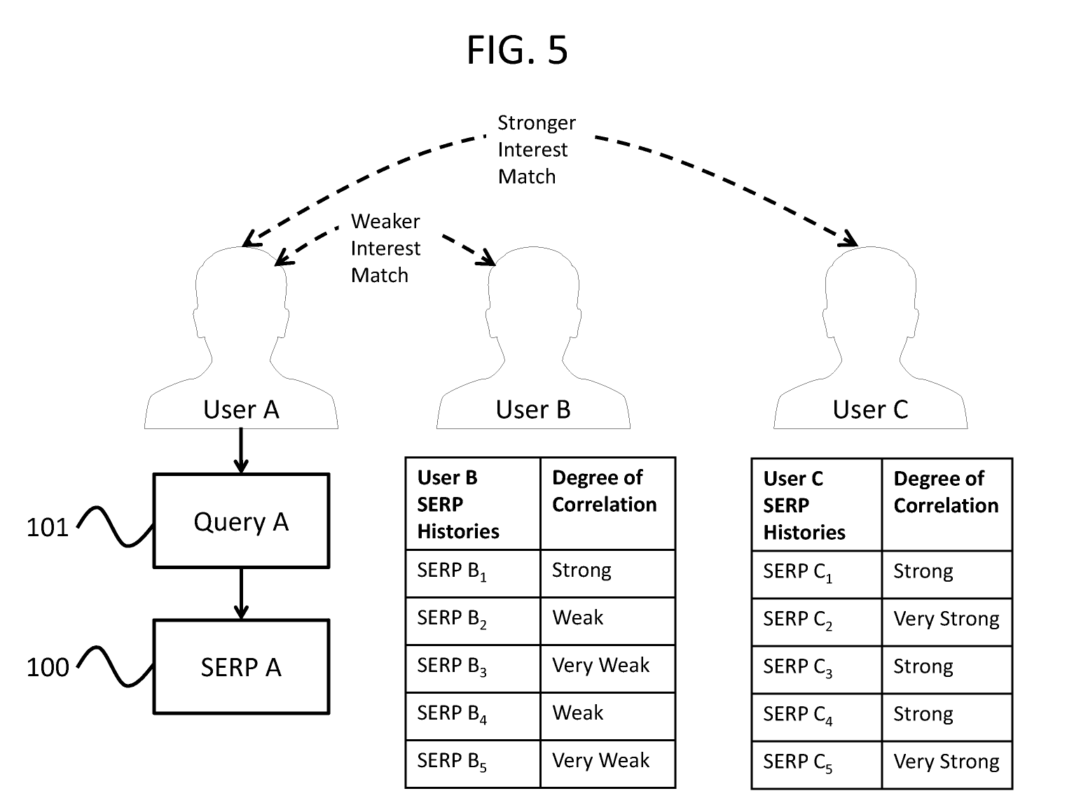

Turning to FIG. 5, it is shown that both User B and User C are associated with different series of SERP histories. User B is associated with SERP histories SERPs B₁-B₅ and User C is associated with SERP histories SERPs C₁-C₅. User A's SERP A 100 may be compared to each of SERPs B₁-B₅ and SERPs C₁-C₅. As illustrated, the different comparisons result in different degrees of correlation. In the example shown in FIG. 5, SERP A 100 compared with SERP B₁ results in a strong degree of correlation. However, when comparing SERP A 100 to SERPs B₂-B₅, it can be seen that there are either weak or very weak degrees of correlation.

Also in the example shown in FIG. 5, SERP A 100 compared with SERP C₁ results in a strong degree of correlation. Additionally, when comparing SERP A 100 to SERPs C₂-C₅, it can be seen that there are either strong or very strong degrees of correlation.

Based on the comparison of SERP A 100 with SERPs C₁-C₅ and the comparison of SERP A 100 with SERPs C₁-C₅, there may be a stronger interest match between User A and User C as compared to User A and User B. Thus, analyses of SERP histories may impact a determination or evaluation of whether one user's interests match another user's interests.

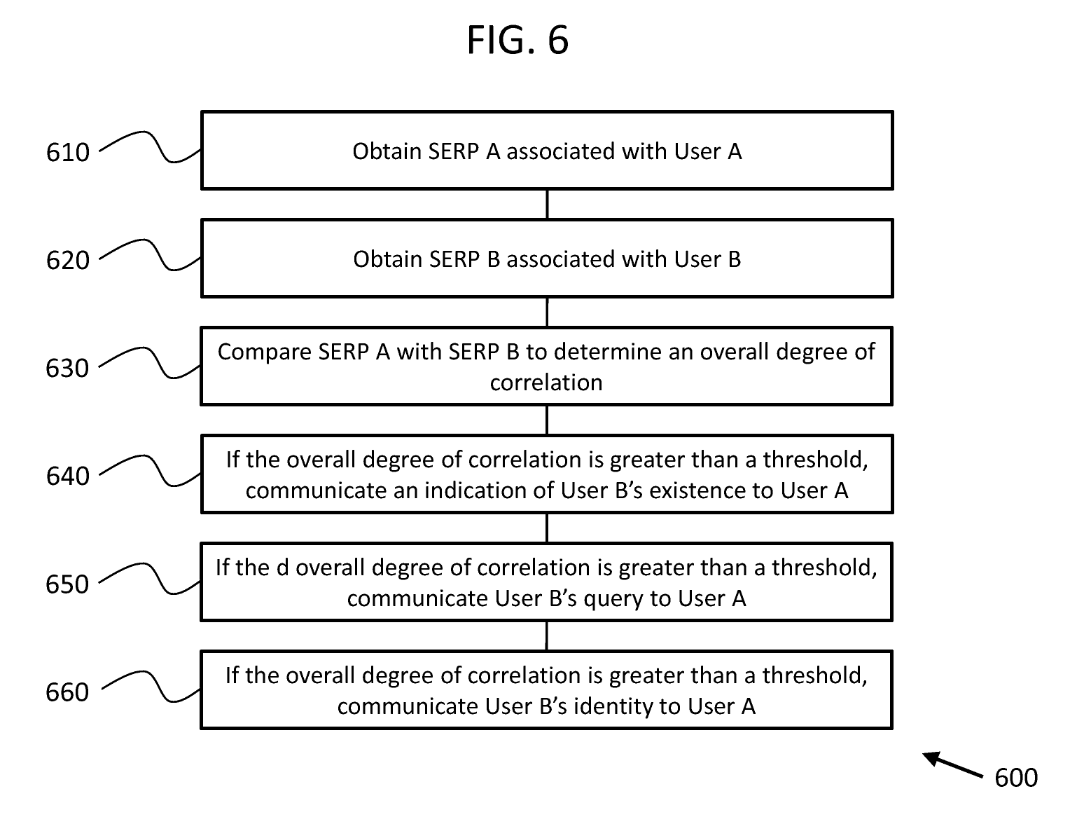

FIG. 6 illustrates a flowchart 600 for a method for comparing SERPs, according to techniques of the present application. The steps illustrated in the flowchart 600 may be performable at least in part by one or more processing units, such as the processing units 1110 and/or 1140. Furthermore, the steps illustrated in the flowchart 600 may be performable in a different order, or some steps may be omitted according to design and/or clinical preferences. For example, step 640 could be omitted or performed after step 650. The steps illustrated in the flowchart 600, or a portion thereof, may be performable by software, hardware, and/or firmware. The steps illustrated in the flowchart 600, or a portion thereof, may also be expressible through a set of instructions stored on one or more computer-readable storage media, such as RAM, ROM, EPROM, EEPROM, optical disk, magnetic disk, magnetic tape, and/or the like.

At step 610, SERP A may be obtained. SERP A may be associated with User A. At step 620, SERP B may be obtained. SERP B may be associated with User B. Each of SERPs A and B may include a query, listings, or related searches. The listings may include titles, URLs, or snippets.

The SERPs may be obtained from volatile or non-volatile memory. For example, SERP A may be obtained in “real time” in relatively immediate response to User A's query. SERP B may be initially stored in non-volatile memory and then later retrieved for comparison with SERP A.

At step 630, SERP A is compared with SERP B to determine an overall degree of correlation. When determining the overall degree of correlation, additional operations may be performed. The queries of SERPs A and B may be compared to determine a query degree of correlation. Titles of SERPs A and B may be compared to determine a title degree of correlation. URLs of SERPs A and B may be compared to determine a URL degree of correlation. Snippets of SERPs A and B may be compared to determine a snippet degree of correlation. Related searches of SERPs A and B may be compared to determine a related search degree of correlation.

Different weights may be assigned to two or more of the query degree of correlation, the title degree of correlation, the URL degree of correlation, the snippet degree of correlation, or the related search degree of correlation. Using the degrees and different weights, the overall degree of correlation may be determined.

At step 640, if the overall degree of correlation is greater than a given threshold, an indication of the existence of User B may be communicated to User A. At step 650, if the overall degree of correlation is greater than a given threshold (this could be a different threshold than the one used in step 640), User B's query may be communicated to User A. At step 660, if the overall degree of correlation is greater than a given threshold (this could be a different threshold than the one used in steps 640 or 650), User B's identity may be communicated to User A.

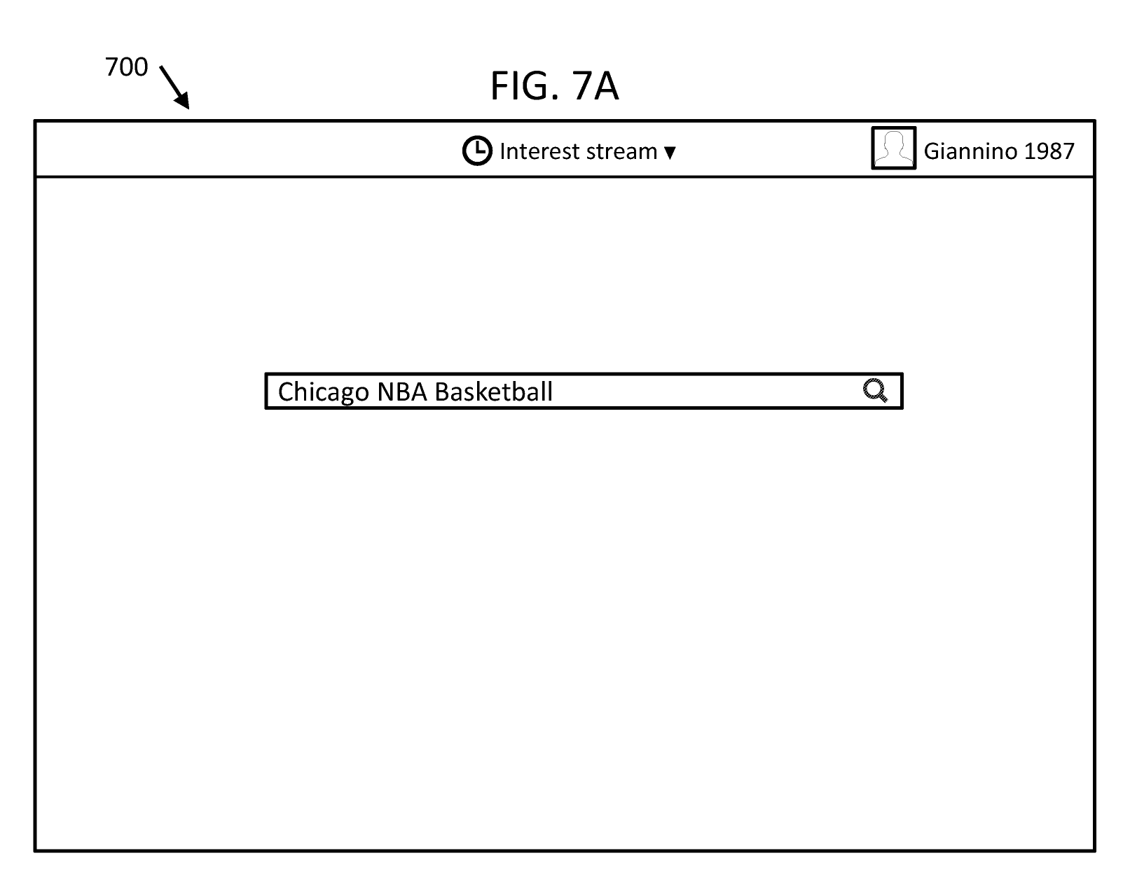

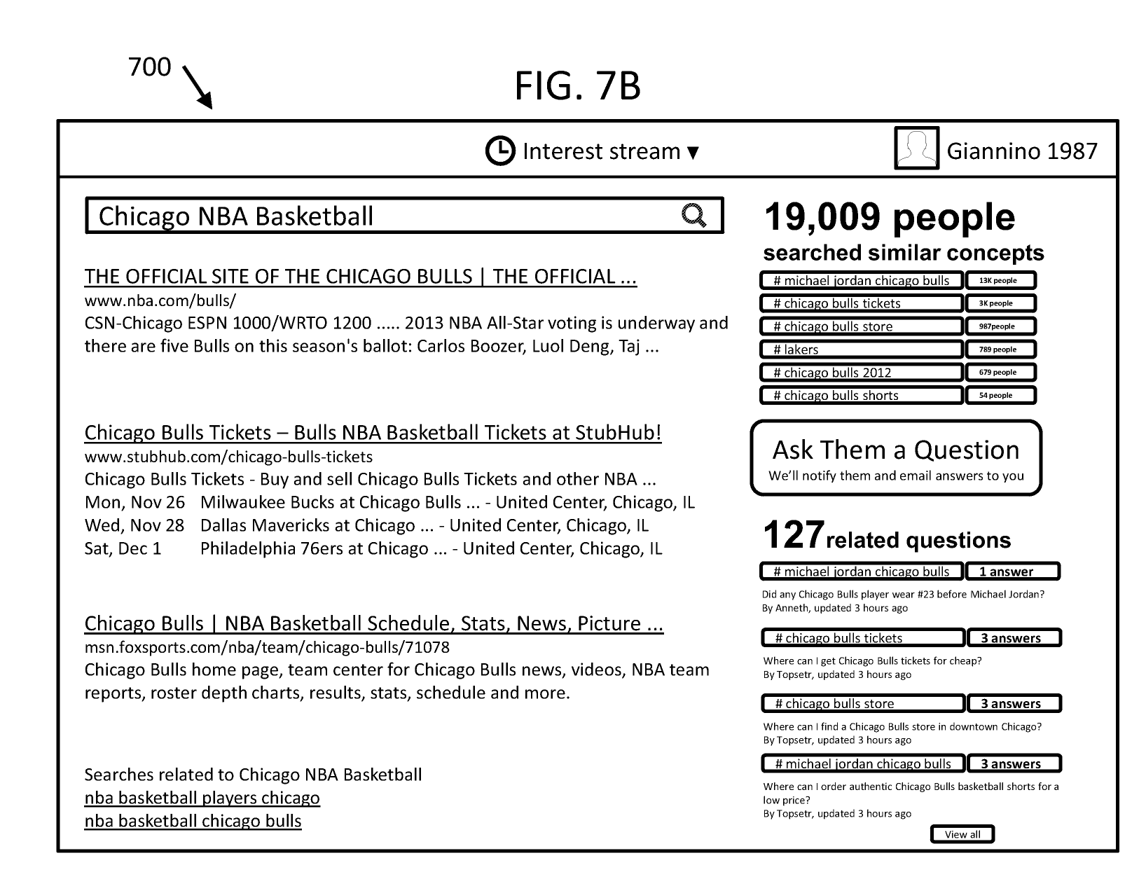

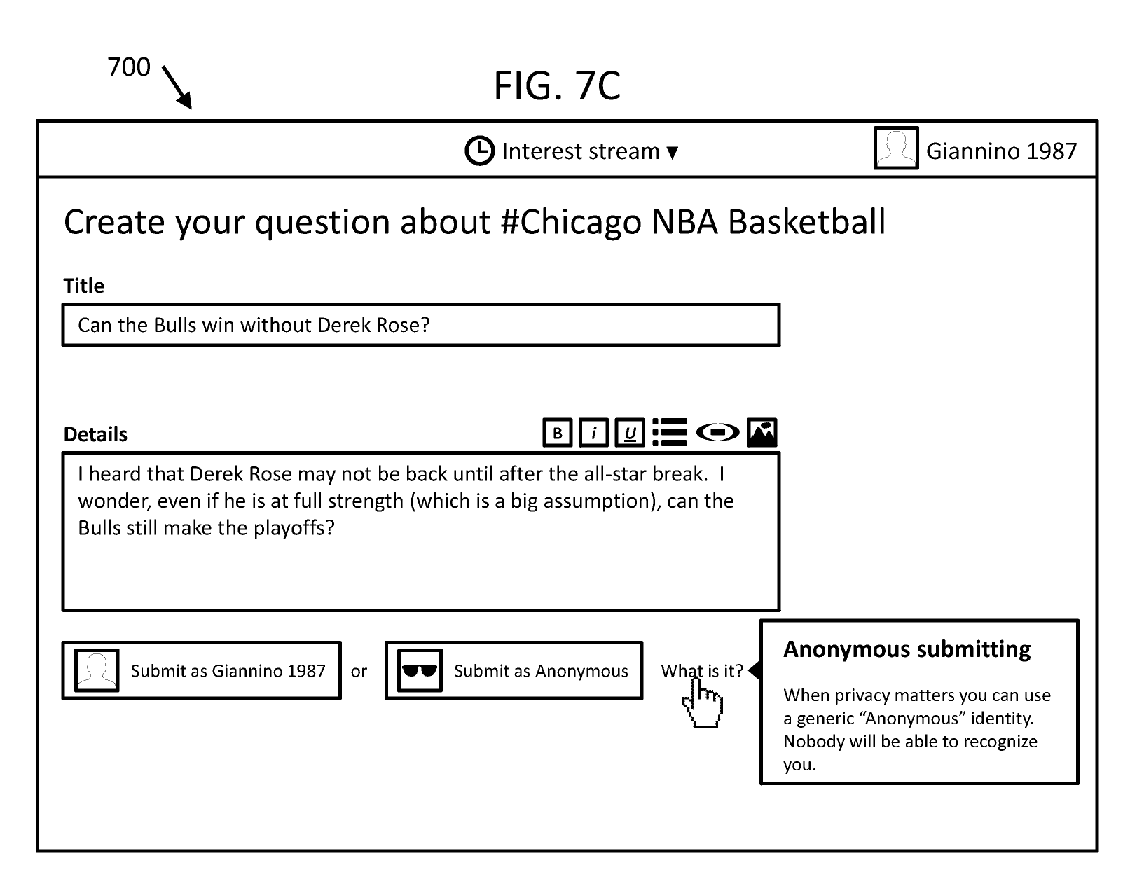

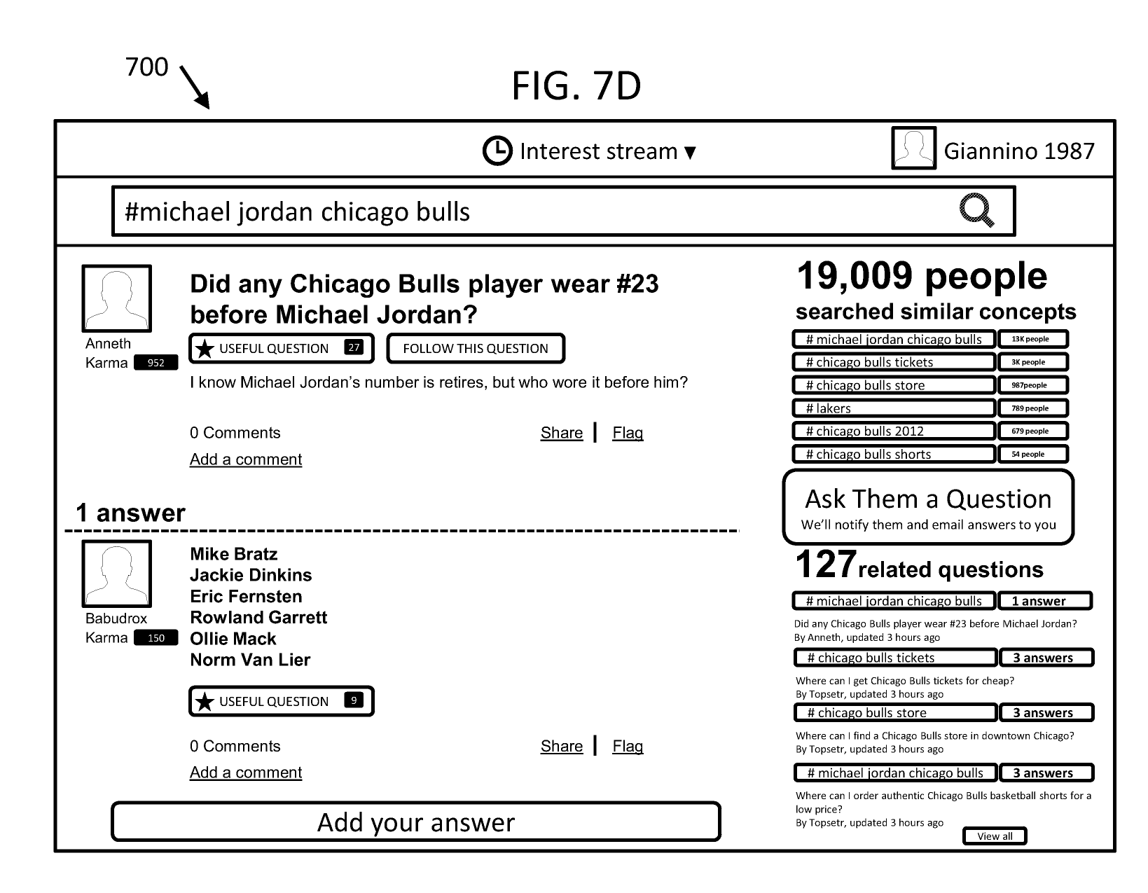

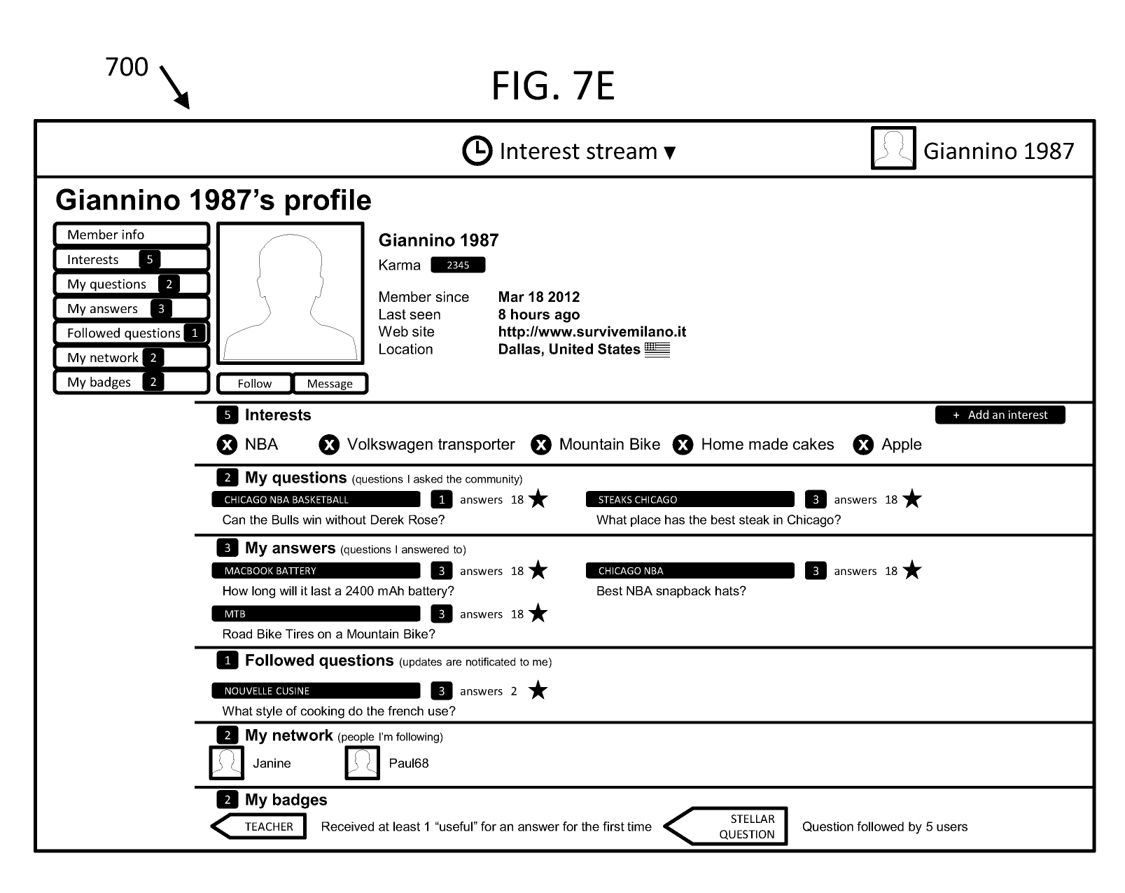

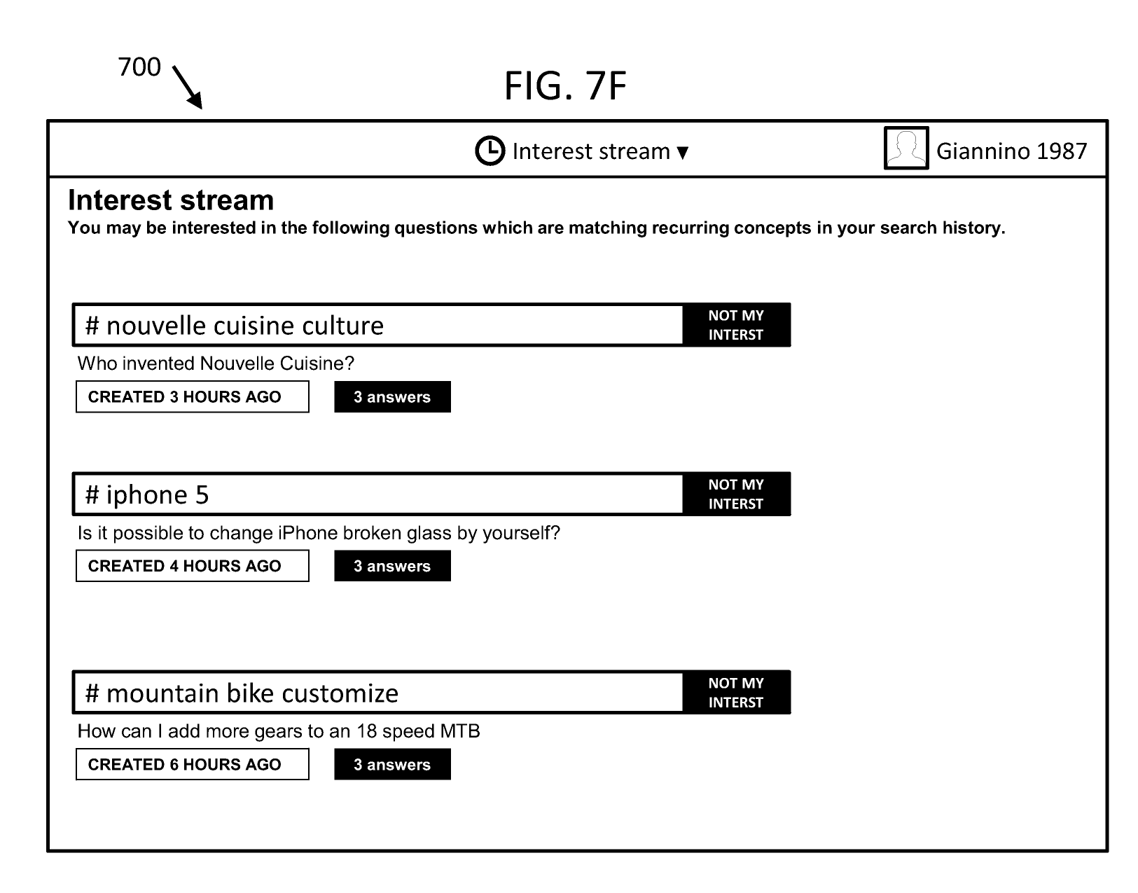

FIGS. 7A-7F illustrate screen shots of a browsing application 700, according to techniques of the present application. The browsing application 700 may implement techniques described herein. The browsing application 700 may include a combination of applications, for example a combination of one or more client or server applications communicating through a network. The browsing application 700 may be associated with one or more memories that may store data associated with the browsing application 700 discussed herein—for example, user profiles and associated data, browsing history, cached webpages, or the like. For the sake of simplicity, a browsing application 700 may, in certain contexts, be understood to access or include such memories.

In FIG. 7A, a home screen of the browsing application 700 is illustrated. The home screen includes a field to enter a search query. In this example, the query “Chicago NBA Basketball” is used. The browsing application may have buttons that link to the user's interest stream (see FIG. 7F) and to the user's profile (see FIG. 7E).

In FIG. 7B, a SERP is illustrated along with additional information. The query, search results, and related searches are returned and displayed on the left side of the browsing application 700. On the right side, the existence of 19,009 other people is displayed or communicated to the user of the browsing application 700. The existence of these other people may be communicated based on the overall degree of correlation between the SERP on the left hand side and the other people's corresponding SERPs being greater than a given threshold. The other people's queries are also displayed or communicated to the user of the browsing application 700. These queries may be communicated based on the overall degree of correlation between the SERP on the left hand side and the other people's corresponding SERPs being greater than a given threshold. These queries include “michael jordan chicago bulls,” “chicago bulls tickets,” “chicago bulls store,” “lakers,” “chicago bulls 2012,” and “chicago bulls shorts.” The number of other users who searched for these similar concepts is displayed to the right of a corresponding query.

Below the similar queries, there is a button that allows the user of the browsing application 700 to ask a question. Below the button, it can be seen that there are 127 questions that have been asked by some of the 19,009 people indicated above in conjunction with the similar searches. For example, user Anneth queried the browsing application 700 with the query “michael jordan chicago bulls.” After receiving the SERP corresponding to this query, Anneth then asked “Did any Chicago Bulls player wear #23 before Michael Jordan?” This question then became associated with Anneth and her query. Then, when the browsing application identified Anneth's query as a related search, her question (which is tagged with her original query “michael jordan chicago bulls”) was displayed in the list of related questions to other users who have done semantically similar queries to “michael jordan chicago bulls.”

Four of the 127 questions are presented in a list form, with an option to “view all” of the questions. Each question listing includes an associated query, a link to view answers to the question, the text of the question, the identity of the user who asked the question, and the time of the last update to the question.

If the user wishes to ask a question, the “Ask Them a Question” button can be clicked or actuated. As indicated, the browsing application 700 will notify others of the question (for example, display the question as a related question upon further similar queries) and will email answers to the user).

If the “Ask Them a Question” button is actuated, then the browsing application 700 may transition to a screen, such as the one shown in FIG. 7C, which depicts a question submission form. The form includes “Title” and “Details” fields for the user to type in the question. An option to insert a hyperlink or an image as part of the “Details” is also provided. The question can be submitted under the user's username (Giannino1987) or anonymously.

If one of the “answers” button depicted in FIG. 7B is actuated, then the browsing application 700 may transition to a screen, such as the one shown in FIG. 7D. For example, assume the user clicked on the “1 answer” button in the first listing of related questions. The screen may then transition to show the question and details. The answer(s) may be shown in a list below the question. An option may be provided for the user to provide an answer. For each answer or question, there may be an icon for an associated user, the user's name, a link to send the user a message, and a Karma score for the user. There may be an option to indicate a question or an answer as being useful. There may also be links to share, flag (for example, flag as inappropriate), or comment on a given question/answer.

FIG. 7E illustrates the user's profile. The user may be able to add or remove “interests,” which may facilitate interest matching with other users. The user profile may display the user's questions and answers as well as a link to the corresponding answers/responses. A rating of a given question/answer may also be displayed. Such a rating may reflect a number of other users who liked or found useful the given question/answer. Through the user profile, it may also be possible to send messages (for example private messages) to other users. A user's “Karma” or reputation may be displayed. This may be an attribute that measures a given user's reputation. The user may also have a network of other users. Such a network may include, for example, other users who are followed or who are following the given user.

FIG. 7F illustrates the user's “interest stream.” The interest stream may be a personal magazine of interesting questions. This magazine may be private and may notify the user of new questions which may be interesting to her. The user may be notified of changes to the interest stream, for example, by periodic or event-driven email.

Questions may be populated in the interest stream in the following manner. When another user creates a new question, the browsing application may attempt to match the question with other users' searches. For example, the question's associated query may be matched with other users' searches. If a given user has performed one or more searches that semantically match the query of the new question, then that new question may be populated in the given user's interest stream. According to one technique, not all searches in a user's search history are candidates for matching. A candidate search may only be relevant if it represents a recurring concept in that user's search history.

In the example of FIG. 7F, the user's interest stream in the browsing application 700 has been populated with three questions. Each entry indicates the question's associated query, the question, a time when the question was created, and a link to the answers to that question. Also, a button is provided to allow the user to indicate that a given question does not reflect that user's interest. If a question is not of interest to a user (and so indicated by actuating the button), then the browsing application 700 may “learn” not to populate the interest stream with similar questions. The populated questions in FIG. 7F may be matched based on the user's search history (for example, query history). Such searches may have included “nouvelle cuisine culture,” “iphone 5,” and “mountain bike customize,” or variations thereof.

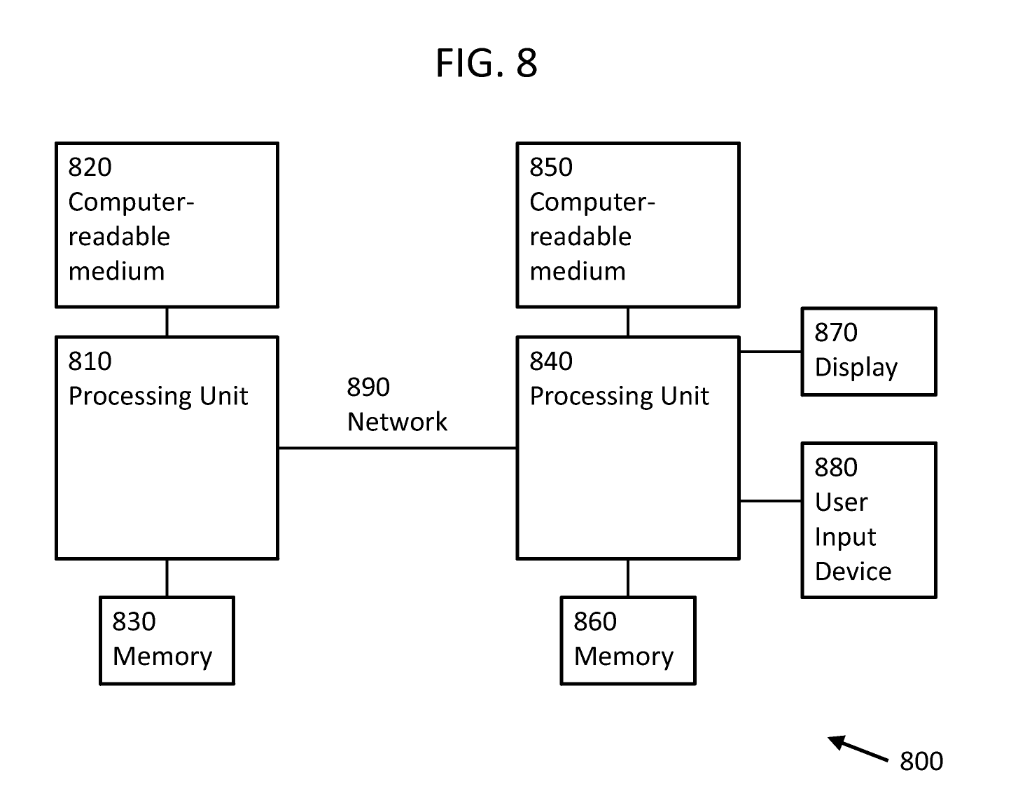

FIG. 8 illustrates a system 800 for implementing the techniques described above in conjunction with FIGS. 1-7. The system 800 may include processing units 810 or 840 which may communicate with each other through a network 890. Each of the processing units 810 or 840 may include multiple processing units. The processing units 810 or 840 may be in communication with one or more computer-readable mediums 820 or 850. The processing units 810 or 840, either individually or in combination, may execute software instructions stored on one or more of the computer-readable mediums 820 or 850. For example, the processing units 810 or 840 may execute software instructions to run a browsing application, such as browsing application 700. As another example, the processing units 810 or 840 may execute software instructions to implement the method depicted in FIG. 6.

The processing units 810 or 840 may be in communication with one or more memories 830 or 860. Each memory 830 or 860 may include multiple memories. These memories may be used for storage and retrieval of information and data associated with the browsing application (for example, user information or browsing history). The processing unit 840 may be in communication with one or more user input devices 880 (for example, a keyboard, mousing device, touch screen, voice control device, camera, or the like). A user may be able to interact with the browsing application through one or more user input devices 880 to perform operations described herein. An interaction may include a mouse movement, mouse click, mouse hover, keyboard input, touch interaction (for example, pinching or touching to zoom in or out), eye movements, body movements, mouse gestures, touch gestures, or the like.

In response to a user interaction, at least one of the processing units 810 or 840 may receive an interaction signal. For example, if a user clicks on or hovers over an icon with a mouse, this may cause the processing unit 840 to receive an icon interaction signal. As another example, if a user clicks on a hyperlink or a shortcut, this may cause the processing unit 840 to receive a navigation signal. These are just a few examples. Any type of interaction with the browsing application may result in a corresponding signal that is received by the processing unit 840.

The processing units 810 or 840 may generate data, such as data used in the browsing application or in the method illustrated in FIG. 6. The processing units 810 or 840 may transmit such data to the display 870.

Aspects of the techniques described herein may be implemented in digital electronic circuitry, computer software, firmware, or hardware, including the structures disclosed herein and their structural equivalents, or in various combinations. Aspects of the techniques described herein may be implemented as one or more computer programs, for example, one or more sets of program instructions residing on or encoded in a computer-readable storage medium for execution by, or to control the operation of, one or more processing units. Alternatively or in addition, the instructions may be encoded on an artificially-generated propagated signal, for example, a machine-generated electrical, optical, or electromagnetic signal that may be generated to encode information for transmission to a suitable receiver apparatus for execution by one or more processing units. A computer-readable medium may be, or be included in, a computer-readable storage device, a computer-readable storage substrate, a random or serial access memory array or device, various combinations thereof. Moreover, while a computer-readable medium may or may not be a propagated signal, a computer-readable medium may be a source or destination of program instructions encoded in an artificially-generated propagated signal. The computer-readable medium may also be, or be included in, one or more separate physical components or media (for example, CDs, disks, or other storage devices).

Certain techniques described in this specification may be implemented as operations performed by one or more processing units on data stored on one or more computer-readable mediums or received from other sources. The term “processing unit” may encompass various kinds of apparatuses, devices, or machines for processing data, including by way of example a central processing unit, a microprocessor, a microcontroller, a digital-signal processor, programmable processor, a computer, a system on a chip, or various combinations thereof. The processing unit may include special purpose logic circuitry, for example, a field programmable gate array or an application-specific integrated circuit.

Program instructions (for example, a program, software, software application, script, or code) may be written in various programming languages, including compiled or interpreted languages, declarative or procedural languages, and may be deployed in various forms, for example as a stand-alone program or as a module, component, subroutine, object, or other unit suitable for use in a computing environment. Program instructions may correspond to a file in a file system. Program instructions may be stored in a portion of a file that holds other programs or data (for example, one or more scripts stored in a markup language document), in a dedicated file or in multiple coordinated files (for example, files that store one or more modules, sub-programs, or portions of code). Program instructions may be deployed to be executed on one or more processing units located at one site or distributed across multiple sites connected by a network.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1-24. (canceled)

25. A method to correlate a plurality of users, comprising:
connecting each one of said plurality of users by means of a network to Internet,
each one of said plurality of users searching into Internet through at least one set of words,
said each one of said plurality of users obtaining a corresponding search engine result page (“SERP”) containing at least one set of word of SERP,
wherein at least a processing unit:
registering at least a first user and a second user of said plurality of users,
registering at least a first of said at least one set of words of SERP sent to said first user and a second of said at least one set of words of SERP sent to said second user,
associating at least said first of said at least one set of words of SERP with said first user and said second of said at least one set of words of SERP with said second user,
adopting a criterion for comparing at least said first of said at least one set of words of SERP of said first user with at least said second of said at least one set of words of SERP of said second user,
comparing at least first of said at least one set of words of SERP of said first user with at least said second of said at least one set of words of SERP of said second user for determining an overall degree of correlation,
determining an overall degree of correlation,
if the overall degree of correlation is greater than a threshold, then
correlating at least said first user with at least said second user and
producing at least a direct and quicker communication link between said at least one of said at least one user and said at least another one of said at least one user of said plurality of users.

26. The method of claim 25, wherein said at least one set of words of SERP comprises at least one of at least one query, at least one title, at least one URL, at least one snippet, at least one related search.

27. The method of claim 25, Wherein said at least a direct and quicker communication link comprises a communication of existence, a communication of query, a communication of identity between said at least one of said at least one user and said at least another one of said at least one user of said plurality of users.

28. The method of claim 27, wherein said communication of existence is above a first of said predefined threshold of correlation, said communication of query is above a second of said predefined threshold of correlation, said communication of identity is above a third of said predefined threshold of correlation.

29. A system to correlate a plurality of users, said system comprising a processing unit including at least one processor and at least one memory having instructions that are executable by the processor to cause the system to perform operations comprising:
each one of said plurality of users connects by means of a network to Internet,
each one of said plurality of users searches into Internet through at least one set of words,
said each one of said plurality of users obtains a corresponding search engine result page (“SERP”) containing at least one set of word of SERP,
wherein the processing unit
registers at least a first user and a second user of said plurality of users,
registers at least a first of said at least one set of words of SERP sent to said first user and a second of said at least one set of words of SERP sent to said second user,
associates at least said first of said at least one set of words of SERP with said first user and said second of said at least one set of words of SERP with said second user,
adopts a criterion for comparing at least said first of said at least one set of words of SERP of said first user with at least said second of said at least one set of words of SERP of said second user,
compares at least first of said at least one set of words of SERP of said first user with at least second of said at least one set of words of SERP of said second user for determining an overall degree of correlation,
determines an overall degree of correlation,
if the overall degree of correlation is greater than a threshold, then
said processing unit correlates at least said first user with at least said second user and
produces at least a direct and quicker communication link between said at least one of said at least one user and said at least another one of said at least one user of said plurality of users.

30. The system of claim 29, wherein said at least one set of words of SERP comprises at least one of at least one query, at least one title, at least one URL, at least one snippet, at least one related search.

31. The system of claim 29, wherein said at least a direct and quicker communication link comprises the processing unit transmitting indication of existence, transmitting the query, transmitting identity between said at least one of said at least one user and said at least another one of said at least one user of said plurality of users.

32. The system of claim 31, wherein said transmitting the indication of existence is above a first of said predefined threshold of correlation, said transmitting the query is above a second of said predefined threshold of correlation, said transmitting the identity is above a third of said predefined threshold of correlation.

33. A computer-readable medium to correlate a plurality of users including instructions executable to cause a system to perform operations comprising:
each one of said plurality of users connects by means of a network to Internet,
each one of said plurality of users searches into Internet through at least one set of words,
said each one of said plurality of users obtains a corresponding search engine result page (“SERP”) containing at least one set of word of SERP,
wherein said at least one computer-readable medium
registers at least a first user and a second user of said plurality of users,
registers at least a first of said at least one set of words of SERP sent to said first user and a
second of said at least one set of words of SERP sent to said second user,
associates at least said first of said at least one set of words of SERP with said first user and said second of said at least one set of words of SERP with said second user, adopts a criterion for comparing at least said first of said at least one set of words of SERP of said first user with at least said second of said at least one set of words of SERP of said second user,
compares at least first of said at least one set of words of SERP of said first user with at least second of said at least one set of words of SERP of said second user for determining an overall degree of correlation,
determines an overall degree of correlation,
if the overall degree of correlation is greater than a threshold, then
said computer-readable medium correlates at least said first user with at least said second user and
produces at least a direct and quicker communication link between said at least one of said at least one user and said at least another one of said at least one user of said plurality of users.

34. The computer-readable medium of claim 33, wherein said at least one set of words of SERP comprises at least one of at least one query, at least one title, at least one URL, at least one snippet, at least one related search.

35. The computer-readable medium of claim 33, wherein said at least a direct and quicker communication link comprises the instructions executable by the system to perform further operations comprising transmitting indication of existence, transmitting the query, transmitting identity between said at least one of said at least one user and said at least another one of said at least one user of said plurality of users.

36. The computer-readable medium of claim 35, wherein said transmitting the indication of existence is above a first of said predefined threshold of correlation, said transmitting the query is above a second of said predefined threshold of correlation, said transmitting the identity is above a third of said predefined threshold of correlation.

37. The computer-readable medium of claim 26, wherein said transmitting the indication of existence is above a first of said predefined threshold of correlation, said transmitting the query is above a second of said predefined threshold of correlation, said transmitting the identity is above a third of said predefined threshold of correlation.

38. The method of claim 30, Wherein said communication of existence is above a first of said predefined threshold of correlation, said communication of query is above a second of said predefined threshold of correlation, said communication of identity is above a third of said predefined threshold of correlation.

39. The system of claim 34, wherein said transmitting the indication of existence is above a first of said predefined threshold of correlation, said transmitting the query is above a second of said predefined threshold of correlation, said transmitting the identity is above a third of said predefined threshold of correlation.
